(19) United States
(12) Patent Application Publication
(10) Pub. No.: US 2023/0234414 A1
(43) Pub. Date: Jul. 27, 2023

(54) TRANSFORMING VEHICLE

(71) Applicant: Frances Jones, Fayetteville, NC (US)

(72) Inventor: Frances Jones, Fayetteville, NC (US)

(21) Appl. No.: 17/585,769

(22) Filed: Jan. 27, 2022

(51) Int. Cl. B60F 5/02; B60F 3/00

(52) U.S. Cl. CPC B60F 5/02; B60F 3/0007; B60F 2301/00

(57) ABSTRACT

A transforming vehicle, including a main body having at least one of a ground mode, a liquid surface mode, and a flight mode, a plurality of side engines disposed on at least a portion of the main body to steer the main body in response to generating thrust from at least one of the plurality of side engines, a plurality of turbines disposed on at least a portion of a rear of the main body to move the main body in a lateral direction in response to rotation of the plurality of turbines, a plurality of wheel assemblies disposed on at least a portion of a bottom of the main body to facilitate movement of the main body over a ground surface, and a plurality of lifting fans disposed on at least a portion of the bottom of the main body to increase an altitude level of the main body during the flight mode, such that the main body flies.

### BACKGROUND

### 1. Field

The present general inventive concept relates generally to a vehicle, and particularly, to a transforming vehicle.

### 2. Description of the Related Art

Internal combustion engine (ICE) vehicles are one of the major contributors to climate change due to pollution as a result of exhaust emitted from the ICE vehicles. In particular, the gases commonly emitted from an ICE vehicle include carbon dioxide, carbon monoxide, water, nitrogen, unburned hydrocarbons, and/or other toxic pollutants, such as particulates. These pollutants are just a few of the consequences associated with driving the ICE vehicle. As such, ICE vehicles pose a significant threat to environmental health.

Additionally, many vehicles are limited to a single function. Specifically, a car is driven on a road, a boat is driven over water, and an aircraft is flown in the air. Unfortunately, this can be inconvenient for travelers depending on the destination. For example, some destinations can be only five miles away, but take an hour to reach due to inefficient roadways and/or traffic conditions.

Therefore, there is a need for a transforming vehicle that uses alternative fuels sources for power and can transform to utilize alternative transportation capabilities.

### SUMMARY

The present general inventive concept provides a transforming vehicle.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a transforming vehicle, including a main body having at least one of a ground mode, a liquid surface mode, and a flight mode, a plurality of side engines disposed on at least a portion of the main body to steer the main body in response to generating thrust from at least one of the plurality of side engines, a plurality of turbines disposed on at least a portion of a rear of the main body to move the main body in a lateral direction in response to rotation of the plurality of turbines, a plurality of wheel assemblies disposed on at least a portion of a bottom of the main body to facilitate movement of the main body over a ground surface, and a plurality of lifting fans disposed on at least a portion of the bottom of the main body to increase an altitude level of the main body during the flight mode, such that the main body flies.

The main body may include an elongated section forming a front portion, a seating section disposed on at least a portion of a center of the elongated section to control at least one function, a panoramic windshield circumferentially disposed around at least a portion of a perimeter of the seating section to cover the seating section, and a plurality of wings disposed on at least a portion of a rear portion of the main body to aerially lift the main body during the flight mode.

The panoramic windshield may be dome shaped to facilitate viewing at any angle above the main body.

The plurality of turbines may have a power level greater than a power level of the plurality of side engines.

Each of the plurality of wheel assemblies may include a plurality of wheels to facilitate movement over the ground surface, an axle removably connected to at least a portion of each of the plurality of wheels to connect the plurality of wheels to each other and facilitate steering of the plurality of wheels, and a plurality of wheel compartments disposed within at least a portion of the main body, each of the plurality of wheel compartments to store at least one of the plurality of wheels therein in response to the plurality of wheels retracting within the plurality of wheel compartments.

Each of the plurality of wheels may retract within the plurality of wheel compartments during at least one of the liquid surface mode and the flight mode.

The plurality of wheel assemblies may steer simultaneously.

The plurality of wheel assemblies may steer independently.

The transforming vehicle may further include a plurality of floating bumpers disposed on at least a portion of the main body to facilitate floating of the main body on a liquid surface.

The transforming vehicle may further include a solar cell disposed on and within at least a portion of the main body to absorb energy from an external light source and send power to at least one of the main body, the plurality of side engines, and the plurality of turbines.

The transforming vehicle may further include a fuel container disposed on and within at least a portion of the main body to receive a at least one of plastic fuel and bio-fuel therein and generate power to at least one of the main body, the plurality of side engines, and the plurality of turbines.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates an isometric top view of a transforming vehicle, according to an exemplary embodiment of the present general inventive concept; and

FIG. 2 illustrates a bottom perspective view of the transforming vehicle, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Transforming Vehicle 100
Main Body 110
Elongated Section 111
Seating Section 112
Panoramic Windshield 113
Wings 114
Side Engines 120
Turbines 130
Wheel Assemblies 140
Wheels 141
Axle 142
Wheel Compartments 142
Lifting Fans 150
Floating Bumpers 160
Solar Cell 170
Fuel Container 180

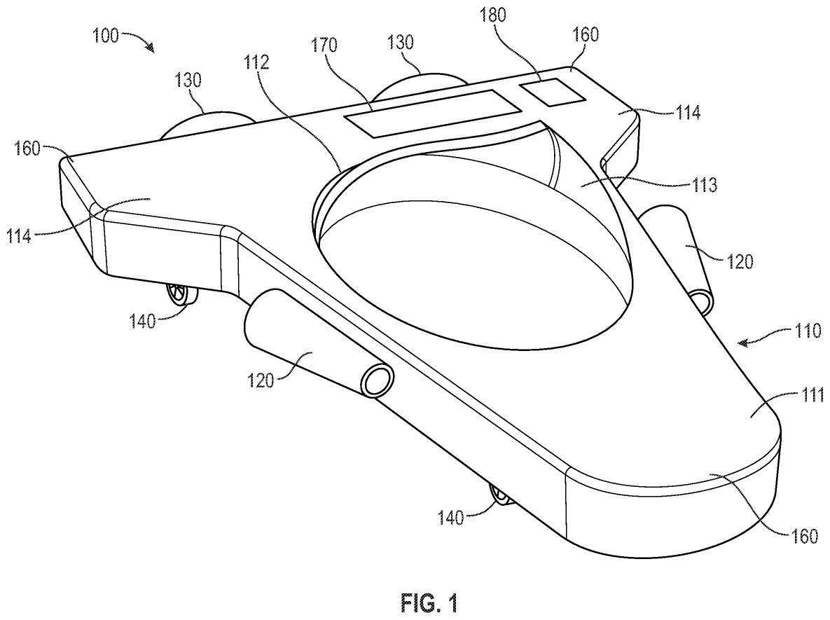

FIG. 1 illustrates an isometric top view of a transforming vehicle 100, according to an exemplary embodiment of the present general inventive concept.

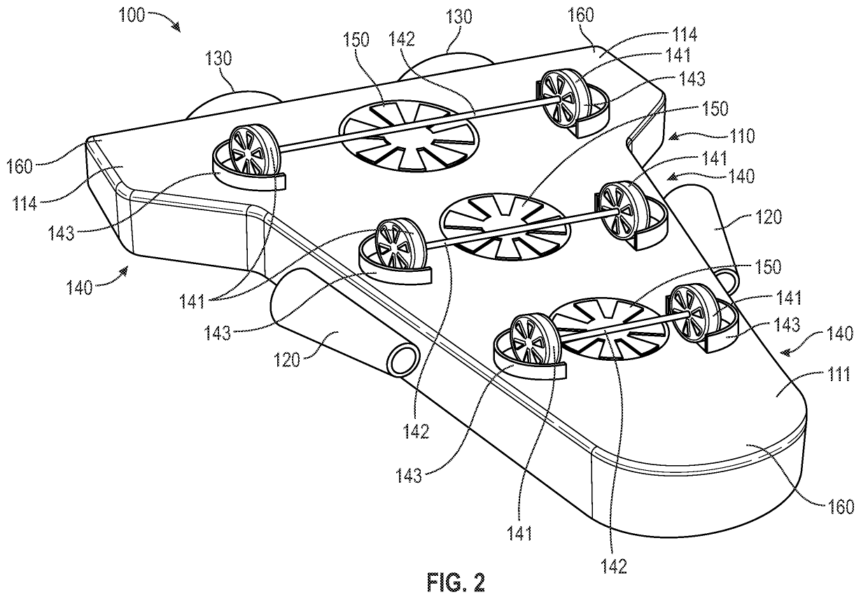

FIG. 2 illustrates a bottom perspective view of the transforming vehicle 100, according to an exemplary embodiment of the present general inventive concept.

The transforming vehicle 100 may be constructed from at least one of metal, plastic, wood, glass, and rubber, etc., but is not limited thereto. Also, the transforming vehicle 100 may be weather proof.

Referring to FIGS. 1 and 2, the transforming vehicle 100 may include a main body 110, a plurality of side engines 120, a plurality of turbines 130, a plurality of wheel assemblies 140, a plurality of lifting fans 150, a plurality of floating bumpers 160, a solar cell 170, and a fuel container 180 but is not limited thereto.

Referring again to FIGS. 1 and 2, the main body 110 is illustrated to have a curved shape and/or a rounded shape on each edge and/or each corner thereof. However, the main body 110 may be constructed to have a sharp shape and/or a flat shape (e.g., ninety-degree angles) on each edge and/or each corner thereof.

The main body 110 may include an elongated section 111, a seating section 112, a panoramic windshield 113, and a plurality of wings 114, but is not limited thereto.

The elongated section 111 may form a front portion of the main body 110 and have an elongate shape.

The seating section 112 may include a seat, a steering wheel, a yoke, a dashboard, and a control panel (e.g., air conditioning controls, radio, flight controls, boat controls, etc.), but is not limited thereto.

The seating section 112 may be disposed on at least a portion of a center of the elongated section 111 and/or a center of an entirety of the main body 110. The seating section 112 may receive at least one user (e.g., a driver, a passenger) therein. Moreover, the seating section 112 may allow the at least one user to control at least one function. In other words, the seating section 112 may receive inputs for different modes of operation to be used, such as ground mode, a liquid surface mode, and/or a flight mode.

The panoramic windshield 113 may be dome shaped to facilitate viewing at any angle above the main body 110, such as any angle above a lateral plane with respect to a top surface of the main body 110 where the panoramic windshield 113 is located. The panoramic windshield 113 may be hingedly disposed on at least a portion of the center of the elongated section 111. Additionally, the panoramic windshield 113 may be circumferentially disposed on and/or around at least a portion of a perimeter of the seating section 112. In other words, the panoramic windshield 113 may at least partially enclose the seating section 112 and/or cover the seating section 112. Furthermore, at least a portion of the panoramic windshield 113 may move (i.e., pivot, rotate) in response to an application of force (e.g., pushing, pulling) thereto. Accordingly, the at least a portion of the panoramic windshield 113 may move from closed against the seating section 112 in a first position to at least partially opened away from the seating section 112 in a second position. Conversely, the at least a portion of the panoramic windshield 113 may move from opened away from the seating section 112 in the second position to closed against the seating section 112 in the first position.

The plurality of wings 114 may be disposed on at least a portion of a rear portion of the main body 110. More specifically, each of the plurality of wings 114 may be disposed on at least a portion of opposing sides (e.g., a first side and/or a second side opposite with respect to the first side) of the main body 110. In other words, the plurality of wings 114 may appear similar to wings of an aircraft (e.g., an airplane). The plurality of wings 114 may facilitate aerial lift of the main body 110 while the main body 110 moves through air (i.e., during flight).

Each of the plurality of side engines 120 may include a small engine, but is not limited thereto.

The plurality of side engines 120 may be disposed on at least a portion of the elongated section 111. More specifically, each of the plurality of side engines 120 may be disposed on at least a portion of opposing sides of the main body 110, similar to each of the plurality of wings 114. The plurality of side engines 120 may generate thrust in response to rotating, such that the main body 110 may move in an opposite direction of the thrust. Additionally, the plurality of side engines 120 may rotate simultaneously and/or individually. For example, a first of the plurality of side engines 120 may rotate while a second of the plurality of side engines 120 remains off. As such, the plurality of side engines 120 may be used for steering.

The plurality of turbines 130 may be disposed on at least a portion of the rear portion of the main body 110. The plurality of turbines 130 may generate thrust in response to rotating, such that the main body 110 may move in an opposite direction of the thrust. In other words, the main body 110 may move laterally in a direction opposite of the thrust in response to rotation of the plurality of turbines 130. Additionally, the plurality of turbines 130 may rotate simultaneously and/or individually. Accordingly, the plurality of turbines 130 may move the main body 110, and be a primary source of propulsion for the main body 110. In other words, the plurality of turbines 130 may have a power level (i.e., thrust) greater than a power level of the plurality of side engines 120.

For example, the plurality of turbines 130 may move the main body 110 while the main body 110 is on a ground surface (e.g., a road), a liquid surface (e.g., a body of water), and/or in the air during flight.

Each of the plurality of wheel assemblies 140 may include a plurality of wheels 141, an axle 142, and a plurality of wheel compartments 143, but is not limited thereto.

Referring again to FIG. 2, the plurality of wheel assemblies 140 may be disposed on at least a portion of a bottom of the main body 110. The plurality of wheels 141 may rotate over the ground surface to facilitate movement of the main body 110 over the ground surface.

The axle 142 may be removably connected to at least a portion of the plurality of wheels 141. The axle 142 may connect each of the plurality of wheels 141 to each other. As such, the plurality of wheels 141 may rotate simultaneously with each other. Also, the axle 142 may facilitate steering of the plurality of wheels 141. Furthermore, each of the plurality of wheel assemblies 140 may move (i.e., steer) simultaneously and/or independently with each other. For example, a front of the plurality of wheel assemblies 140 may rotate right while a rear of the plurality of wheel assemblies 140 rotates right and a center of the plurality of wheel assemblies 140 remains straight (i.e., does not rotate).

The plurality of wheel compartments 143 may be disposed within at least a portion of the main body 110. Each of the plurality of wheel compartments 143 may receive and/or store at least one of the plurality of wheels 141 therein. Specifically, each of the plurality of wheels 141 may move within the plurality of wheel compartments 143 after the main body 110 has entered the liquid surface and/or is in flight. In other words, each of the plurality of wheels 141 may retract within the plurality of wheel compartments 143 during the liquid surface mode and/or the flight mode.

Each of the plurality of lifting fans 150 may include a dual rotor, but is not limited thereto. For example, each of the plurality of lifting fans 150 may include a a single rotor, a triple rotor, a quad rotor, and/or any other number of rotors known to one of ordinary skill in the art.

The plurality of lifting fans 150 may be disposed on at least a portion of the bottom of the main body 110. Moreover, the plurality of lifting fans 150 may move (i.e., rotate) to lift the main body 110 above the ground surface, such that the main body 110 may fly. In particular, the plurality of lifting fans 150 may rotate in response to turning on and/or during the flight mode, instead of the ground mode and/or the liquid surface mode. The plurality of lifting fans 150 may increase an altitude level of the main body 110 with respect to the ground surface, such that the main body 110 may fly and/or hover.

Referring again to FIGS. 1 and 2, the plurality of floating bumpers 160 are illustrated to be disposed on each corner at a rear of the main body 110 and/or around a front of the elongated section 111. However, the plurality of floating bumpers 160 may be disposed on at least a portion of any portion of the main body 110. Each of the plurality of floating bumpers 160 may absorb an impact from an external object thereto (e.g., crash from another vehicle, a rock, an animal, a person, etc.). Furthermore, each of the plurality of floating bumpers 160 may facilitate floating of the main body 110 within the liquid surface, such that the main body 110 may move across the liquid surface.

The solar cell 170 may include a battery, but is not limited thereto.

The solar cell 170 may be disposed on and/or within at least a portion of the main body 110. The solar cell 170 may absorb energy from an external light source (e.g., the Sun, ultraviolet (UV) light). Moreover, the solar cell 170 may send power to the main body 110, the plurality of side engines 120, the plurality of turbines 130, and/or the plurality of lifting fans 150.

The fuel container 180 may be disposed on and/or within at least a portion of the main body 110. The fuel container 180 may receive a fuel source therein. Specifically, the fuel container 180 may receive plastic fuel and/or bio-fuel. In other words, the fuel container 180 may only use non-fossil based fuels. The fuel container 180 may include a combustion chamber to generate power for the main body 110, the plurality of side engines 120, the plurality of turbines 130, and/or the plurality of lifting fans 150.

Therefore, the transforming vehicle 100 may adjust to different transportation methods, such as driving on the road, moving through water, and/or flying in the sky. Also, the transforming vehicle 100 may prevent climate change due to lack of requiring fossil fuels for power.

The present general inventive concept may include a transforming vehicle 100, including a main body 110 having at least one of a ground mode, a liquid surface mode, and a flight mode, a plurality of side engines 120 disposed on at least a portion of the main body 110 to steer the main body 110 in response to generating thrust from at least one of the plurality of side engines 120, a plurality of turbines 130 disposed on at least a portion of a rear of the main body 110 to move the main body 110 in a lateral direction in response to rotation of the plurality of turbines 130, a plurality of wheel assemblies 140 disposed on at least a portion of a bottom of the main body 110 to facilitate movement of the main body 110 over a ground surface, and a plurality of lifting fans 150 disposed on at least a portion of the bottom of the main body 110 to increase an altitude level of the main body 110 during the flight mode, such that the main body 110 flies.

The main body 110 may include an elongated section 111 forming a front portion, a seating section 112 disposed on at least a portion of a center of the elongated section 111 to control at least one function, a panoramic windshield 113 circumferentially disposed around at least a portion of a perimeter of the seating section 112 to cover the seating section 112, and a plurality of wings 114 disposed on at least a portion of a rear portion of the main body 110 to aerially lift the main body 110 during the flight mode.

The panoramic windshield 113 may be dome shaped to facilitate viewing at any angle above the main body 110.

The plurality of turbines 130 may have a power level greater than a power level of the plurality of side engines 120.

Each of the plurality of wheel assemblies 140 may include a plurality of wheels 141 to facilitate movement over the ground surface, an axle 142 removably connected to at least a portion of each of the plurality of wheels 141 to connect the plurality of wheels 141 to each other and facilitate steering of the plurality of wheels 141, and a plurality of wheel compartments 143 disposed within at least a portion of the main body 110, each of the plurality of wheel compartments 143 to store at least one of the plurality of wheels 141 therein in response to the plurality of wheels 141 retracting within the plurality of wheel compartments 143.

Each of the plurality of wheels 141 may retract within the plurality of wheel compartments 143 during at least one of the liquid surface mode and the flight mode.

The plurality of wheel assemblies 140 may steer simultaneously.

The plurality of wheel assemblies 140 may steer independently.

The transforming vehicle 100 may further include a plurality of floating bumpers 160 disposed on at least a portion of the main body 110 to facilitate floating of the main body 110 on a liquid surface.

The transforming vehicle 100 may further include a solar cell 170 disposed on and within at least a portion of the main body 110 to absorb energy from an external light source and send power to at least one of the main body 110, the plurality of side engines 120, and the plurality of turbines 130.

The transforming vehicle 100 may further include a fuel container 180 disposed on and within at least a portion of the main body 110 to receive a at least one of plastic fuel and bio-fuel therein and generate power to at least one of the main body 110, the plurality of side engines 120, and the plurality of turbines 130.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A transforming vehicle, comprising:
a main body having at least one of a ground mode, a liquid surface mode, and a flight mode;
a plurality of side engines disposed on at least a portion of the main body to steer the main body in response to generating thrust from at least one of the plurality of side engines;
a plurality of turbines disposed on at least a portion of a rear of the main body to move the main body in a lateral direction in response to rotation of the plurality of turbines;
a plurality of wheel assemblies disposed on at least a portion of a bottom of the main body to facilitate movement of the main body over a ground surface; and
a plurality of lifting fans disposed on at least a portion of the bottom of the main body to increase an altitude level of the main body during the flight mode, such that the main body flies.

2. The transforming vehicle of claim 1, wherein the main body comprises:
an elongated section forming a front portion;
a seating section disposed on at least a portion of a center of the elongated section to control at least one function;
a panoramic windshield circumferentially disposed around at least a portion of a perimeter of the seating section to cover the seating section; and
a plurality of wings disposed on at least a portion of a rear portion of the main body to aerially lift the main body during the flight mode.

3. The transforming vehicle of claim 2, wherein the panoramic windshield is dome shaped to facilitate viewing at any angle above the main body.

4. The transforming vehicle of claim 1, wherein the plurality of turbines have a power level greater than a power level of the plurality of side engines.

5. The transforming vehicle of claim 1, wherein each of the plurality of wheel assemblies comprises:
a plurality of wheels to facilitate movement over the ground surface;
an axle removably connected to at least a portion of each of the plurality of wheels to connect the plurality of wheels to each other and facilitate steering of the plurality of wheels; and
a plurality of wheel compartments disposed within at least a portion of the main body, each of the plurality of wheel compartments to store at least one of the plurality of wheels therein in response to the plurality of wheels retracting within the plurality of wheel compartments.

6. The transforming vehicle of claim 5, wherein each of the plurality of wheels retract within the plurality of wheel compartments during at least one of the liquid surface mode and the flight mode.

7. The transforming vehicle of claim 1, wherein the plurality of wheel assemblies steer simultaneously.

8. The transforming vehicle of claim 1, wherein the plurality of wheel assemblies steer independently.

9. The transforming vehicle of claim 1, further comprising:
a plurality of floating bumpers disposed on at least a portion of the main body to facilitate floating of the main body on a liquid surface.

10. The transforming vehicle of claim 1, further comprising:
a solar cell disposed on and within at least a portion of the main body to absorb energy from an external light source and send power to at least one of the main body, the plurality of side engines, and the plurality of turbines.

11. The transforming vehicle of claim 1, further comprising:
a fuel container disposed on and within at least a portion of the main body to receive a at least one of plastic fuel and bio-fuel therein and generate power to at least one of the main body, the plurality of side engines, and the plurality of turbines.
